(19) United States
(12) Patent Application Publication
(10) Pub. No.: US 2022/0197477 A1
(43) Pub. Date: Jun. 23, 2022

(54) INFORMATION PROCESSING APPARATUS AND NON-TRANSITORY COMPUTER READABLE MEDIUM STORING PROGRAM

(71) Applicant: FUJIFILM Business Innovation Corp., Tokyo (JP)

(72) Inventor: Yuki TODA, Kanagawa (JP)

(73) Assignee: FUJIFILM Business Innovation Corp., Tokyo (JP)

(21) Appl. No.: 17/326,357

(22) Filed: May 21, 2021

(30) Foreign Application Priority Data
Dec. 23, 2020 (JP) 2020-213380

(51) Int. Cl. G06F 3/0481; G06F 3/0484; G06F 3/0487

(52) U.S. Cl. CPC G06F 3/04812; G06F 2203/04803; G06F 3/0487; G06F 3/0484

(57) ABSTRACT

An information processing apparatus includes a processor configured to receive a process from a user and execute the process on a component that is associated with the process and constitutes at least a part of a fixed form.

### CROSS-REFERENCE TO RELATED APPLICATIONS

This application is based on and claims priority under 35 USC 119 from Japanese Patent Application No. 2020-213380 filed Dec. 23, 2020.

### BACKGROUND

### (i) Technical Field

The present invention relates to an information processing apparatus and a non-transitory computer readable medium storing a program.

### (ii) Related Art

For example, JP2003-186671A discloses a system that uses a calculator to create a customized screen that serves as a user interface for a document management application, in which the system is a customized screen creation system for a document management system including a unit configured to generate and display a display screen determined from a selected business and a selected business process, a unit configured to save an option item selected via the display screen in a memory, a unit configured to extract a necessary display part according to the selected business process, which is a display part constituting a part or the whole of a customized screen, a unit configured to modify the extracted display part according to the selected option item, and a unit configured to collect the modified display part to create and display a customized screen.

### SUMMARY

Here, in a case where a document is created using a fixed form according to a business procedure, it may be difficult for a user to grasp a frame (that is, a component constituting the fixed form) in which a process corresponding to the business procedure is to be executed in the fixed form.

Aspects of non-limiting embodiments of the present disclosure relate to an information processing apparatus and a non-transitory computer readable medium storing a program that make it easier for a user to grasp a component to be processed as compared with a case where a component constituting a document and a process are not associated with each other.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to receive a process from a user and execute the process on a component that is associated with the process and constitutes at least a part of a fixed form.

### BRIEF DESCRIPTION OF THE DRAWINGS

Exemplary embodiment(s) of the present invention will be described in detail based on the following figures, wherein:

FIG. 1 is a diagram showing an overall configuration of a document creation system to which this exemplary embodiment is applied;

FIG. 2 is a block diagram illustrating a function of a user terminal;

FIG. 3 is a diagram showing a fixed form displayed on a display of the user terminal;

FIG. 4 is a diagram illustrating task settings in the fixed form;

FIG. 5 is a diagram illustrating an association relationship between a frame and a task;

FIGS. 6A and 6B are diagrams showing a state where a plurality of documents are displayed in a workspace, FIG. 6A shows a case where a document A is selected from a plurality of documents, and FIG. 6B shows a case where a document B is selected from the plurality of documents;

FIG. 7 is a diagram illustrating a case where a new fixed form is created using a data resource such as a created fixed form;

FIG. 8 is a diagram illustrating a case where a new fixed form is created using a data resource such as a created fixed form, parts (a) to (c) in FIG. 8 are shown in time series;

FIG. 9 is a diagram illustrating a case where a business document is created using the fixed form;

FIG. 10 is a diagram illustrating a case where a business document is created using the fixed form;

FIG. 11 is a diagram illustrating a case where a business document is created using the fixed form; and

FIG. 12 is a flowchart illustrating a flow of creating and using the fixed form.

### DETAILED DESCRIPTION

Hereinafter, exemplary embodiments of the present invention will be described in detail with reference to the accompanying drawings.

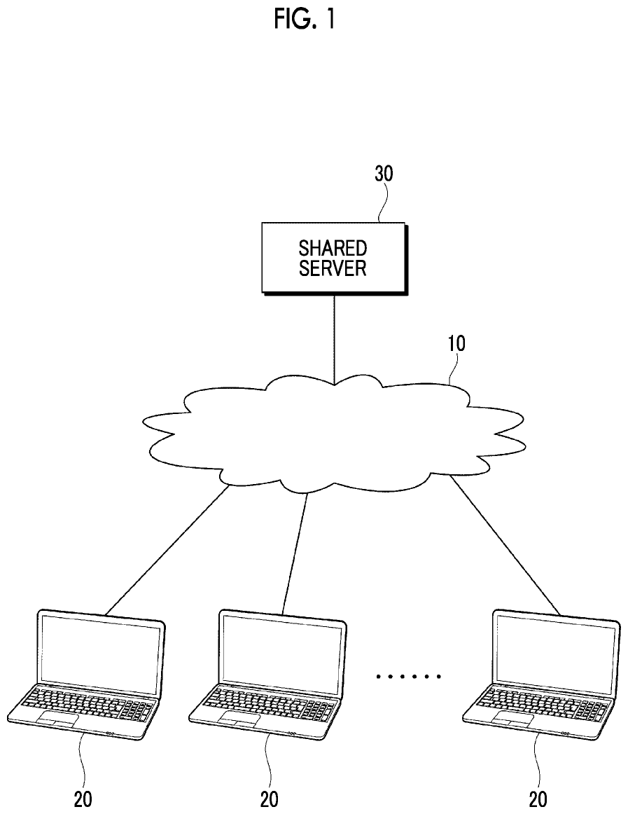

FIG. 1 is a diagram showing an overall configuration of a document creation system 1 to which this exemplary embodiment is applied.

The document creation system 1 shown in FIG. 1 is composed of a network 10, user terminals 20 operated by users who use the system, and a shared server 30 having data used for creating a document in the user terminal 20.

The document in this exemplary embodiment is, for example, an office document created by office software or other application programs, and is created according to a predetermined business procedure by using a fixed form.

The fixed form referred to here is configured to include a workflow in which a task group including tasks representing each work according to a business procedure is arranged in one direction according to the order of the business procedure and frames, document parts, or entry fields associated with each task in the task group (hereinafter referred to as a “frame”).

For the network 10, for example, a local area network (LAN) or the Internet is used. However, the network 10 may have a composite configuration of a LAN and the Internet.

The user terminal 20 is, for example, a laptop computer, a desktop computer, a tablet computer, or a smartphone, and is used for uploading a document or downloading a document to and from the shared server 30.

Each user terminal 20 has a motherboard in which a circuit for processing data is integrated, a storage that stores data, a display used for displaying information, a touch panel or a keyboard used for inputting operations, and a communication module used for communication with the network 10.

The motherboard is provided with, for example, a processor, a random access memory (RAM) used as an execution area of a program, and a read only memory (ROM) that stores a basic input/output system (BIOS) and the like.

Further, a hard disk device or a rewritable non-volatile semiconductor memory is used for the storage.

Although a plurality of user terminals 20 are drawn in FIG. 1, the number of user terminals 20 may be one.

The shared server 30 provides a cloud service that supports the sharing of documents. In the case of FIG. 1, the number of shared servers 30 is one, but the shared server 30 may be physically composed of a plurality of servers. For example, the shared server 30 may be configured as a so-called cloud server. However, the shared server 30 may be an on-premises type server.

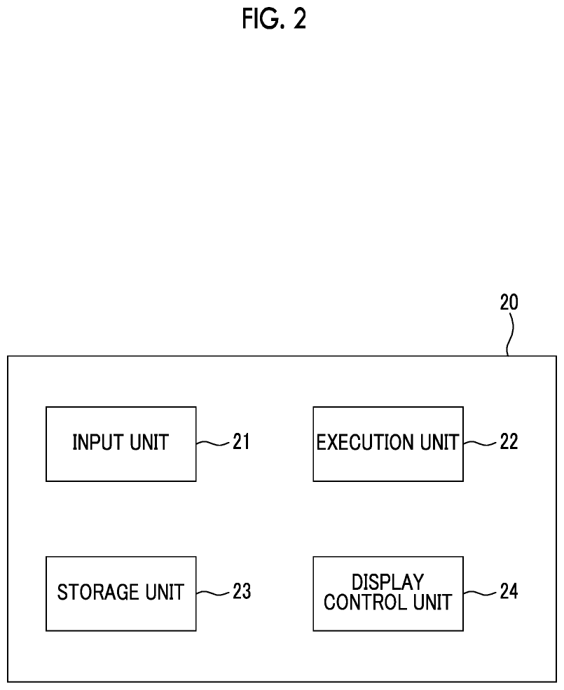

FIG. 2 is a block diagram illustrating a function of the user terminal 20.

As shown in FIG. 2, the user terminal 20 includes an input unit 21 to which an instruction by the user is input when a document is created using a fixed form, an execution unit 22 that executes a process according to the instruction input to the input unit 21, a storage unit 23 that stores information in which a task and a frame of the fixed form are associated with each other, and a display control unit 24 that controls a display of the fixed form or the like on a display.

The task of the fixed form displayed on the display by the display control unit 24 receives the process, and the instruction of the received process is input to the input unit 21. The execution unit 22 specifies a process to be executed and a frame based on the instruction input to the input unit 21 and the information of the storage unit 23, and executes the process for the frame. The result of execution by the execution unit 22 is reflected on the display by the display control unit 24.

The user terminal 20 is an example of an information processing apparatus. In the fixed form, the task is an example of a process execution element, and the frame is an example of a component. The process execution element referred to here means an element that constitutes at least a part of the fixed form displayed on a display and that receives a process through an operation on itself by the user. Further, the component referred to here includes a component that constitutes at least a part of the fixed form and that is associated with a task, and a component that is not associated with the task. In the fixed form, there is a one-to-one correspondence between tasks and frames.

Further, the process referred to here means addition, editing, or the like of a frame in the fixed form.

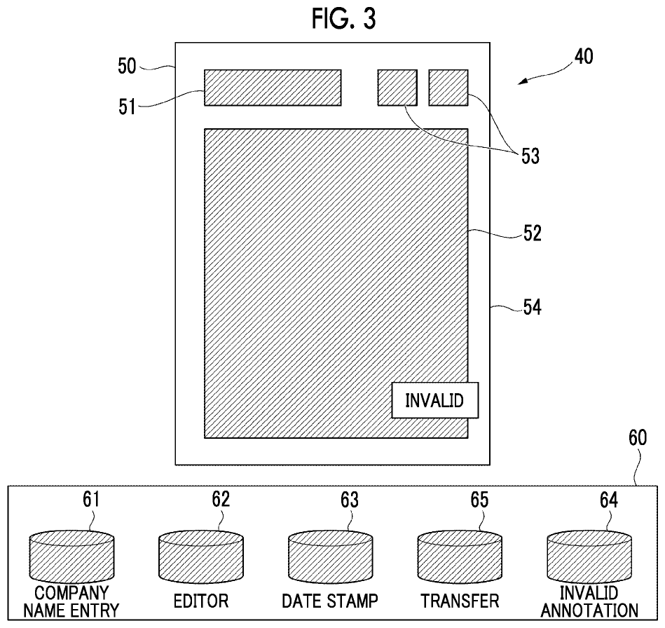

FIG. 3 is a diagram showing a fixed form 40 displayed on a display of the user terminal 20.

The fixed form 40 shown in FIG. 3 is a completed form configured to include a document template 50 including a plurality of frames 51, 52, 53, and 54 and an area 60 of the workflow including tasks 61, 62, 63, 64, and 65. The user can complete a document according to the business procedure by using the fixed form 40 on the user terminal 20.

The frames 51 to 54 of the document template 50 constitute a part of the fixed form 40.

Of the tasks 61 to 65 in the area 60, the tasks 61, 62, 63, and 64 are associated with any of the frames 51 to 54 in a one-to-one correspondence, and the task 65 is not associated with any of the frames 51 to 54.

Each of the tasks 61 to 64 executes individually preset processes for the associated frames 51 to 54.

For example, in a case where the user clicks, operates, or designates the task 61 (hereinafter referred to as “designation”), the process set in the task 61 is received, and the received process is executed for the frame 51 associated with the task 61. In other words, the task 61 receives the process from the user, and executes the received process for the frame 51.

Similarly, in a case where each of the tasks 62 to 64 is designated, the process for each of the associated frames 52 to 54 is executed.

In this exemplary embodiment, the task 61 is displayed together with a task name “company name entry”, and the task 62 is displayed together with a task name “editor”. The task 63 is displayed together with a task name “date stamp”, and the task 64 is displayed together with a task name “invalid annotation”. Further, the task 65 is displayed together with a task name “transfer”.

The task 61 is for performing a process of entering a predetermined company name in the frame 51. The task 62 is for performing a process of entering any text in the frame 52. The task 63 is for performing a process of entering a date in the frame 53. The task 64 is for performing a process of adding, for example, an “invalid” mark indicating unavailable to the frame 54. The “annotation” in the task 64 means an annotation for adding some image or the like to a document.

In addition, since the “transfer” in the task 65 is to send the entire document template 50 to an approver, for example, in a case of performing the business of creating a document using the fixed form 40, the task 65 is not associated with any of the frames 51 to 54, but is associated with the entire document template 50.

The tasks 61 to 65 are located in the area 60 of the workflow described above. The tasks 61 to 65 are arranged side by side in a row in the area 60. When creating a document using the fixed form 40 on the user terminal 20, the work procedure can be followed by performing the work according to the arrangement order or arrangement position of the tasks 61 to 65 in the area 60 from the left to the right. That is, the user can complete the document while checking the document form being created by sequentially designating the tasks 61 to 65 in the area 60 of the workflow arranged near the document template 50.

In this exemplary embodiment, the “company name entry” is located on the leftmost side in the area 60 and is performed first. After that, “editor”, “date stamp”, and “transfer” are sequentially performed. The “invalid annotation” is located on the rightmost side because the task is performed as needed, is not always performed, and is generally performed at the final stage.

In the fixed form 40 shown in FIG. 3, the frames 51 to 54 are associated with any of the tasks 61 to 64 in the area 60, but the fixed form 40 may be configured to include a fixed frame that is not associated with any of the tasks 61 to 64.

Next, a case where task settings in the fixed form 40 are performed will be described.

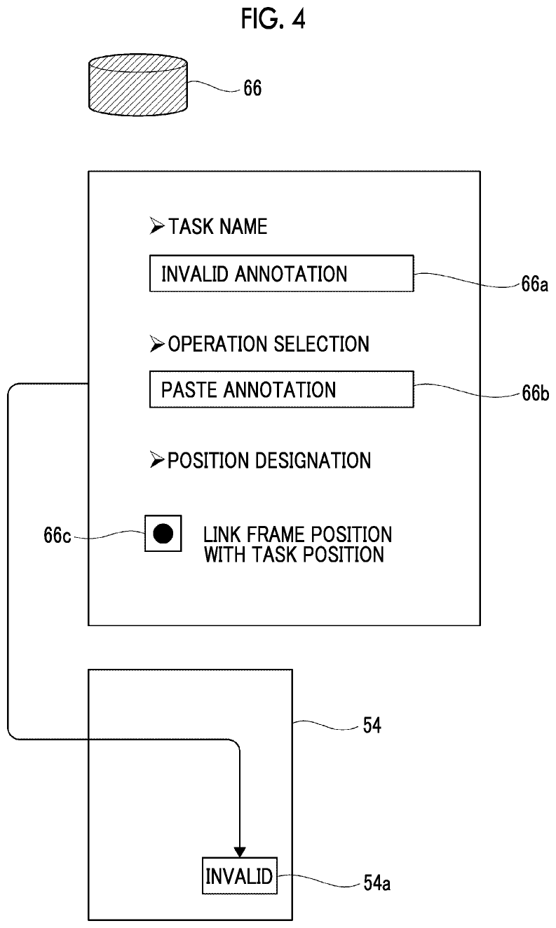

FIG. 4 is a diagram illustrating task settings in the fixed form 40.

At the time of task settings, each task to be arranged in the area 60 of the workflow is defined and created. Specifically, a task 66 to be set is displayed on the setting screen shown in FIG. 4. Task settings are possible by inputting in respective items of task name, operation selection, and position designation of the task 66.

The task name is displayed near the task 66, and the input is assisted by typical options set in a task name pull-down menu 66a.

The operation selection is the content of the process executed in a case where the task 66 is designated, and the input is assisted by typical options set in an operation selection pull-down menu 66b.

FIG. 4 shows a state where “invalid annotation” is selected as the task name and “paste annotation” is selected as the operation selection. In such a case, an “invalid” mark 54a is added to the frame 54 by the process of the task 66.

The position designation is designated on/off by a check box 66c, and in a case of on designation, the position of the task 66 in the area 60 is changed according to the change in the arrangement of the frame, and the task execution order is changed. Further, in a case where the arrangement order of the tasks 66 in the area 60 is changed in the on designation, the position of the associated frame may be changed according to the change.

The default value of the on/off designation of the check box can be changed depending on the process content selected for the task operation. For example, since the date stamp is considered to be executed in the latter half of the execution order, the off designation may be set as the default value regardless of the frame position.

In this way, the check box 66c is selectable between a case where, with a change in the position in the fixed form 40 of one of the frame 54 and the task 66, the position in the fixed form 40 of the other one is changed according to the change, and a case where the position in the fixed form 40 of one of the frame 54 and the task 66 is changed but the position in the fixed form 40 of the other one is not changed.

In the example shown in FIG. 4, the editing is performed by the menu method, but the present invention is not limited to this. As another setting method, a task with a higher degree of freedom may be created through a setting file, programming, a macro, or the like.

Here, each task in the area 60 has a display state before and after the process is executed, and the states that are different from each other before and after the process may be displayed in the associated document template 50 and/or the area 60 of the workflow.

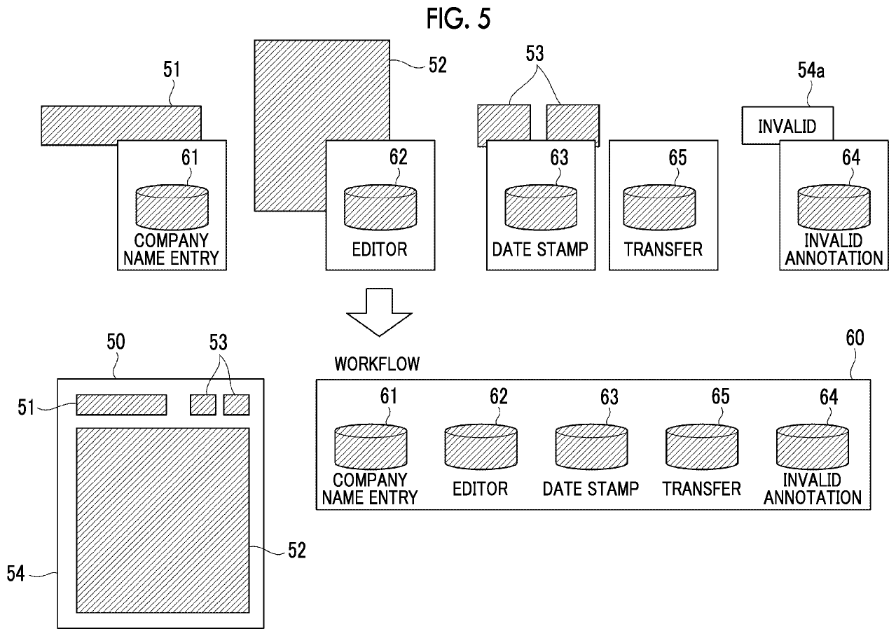

FIG. 5 is a diagram illustrating an association relationship between the frames 51 to 54 and the tasks 61 to 65.

The frame 51 is associated with the task 61 of the task name “company name entry”, the frame 52 is associated with the task 62 of the task name “editor”, and the frame 53 is associated with the task 63 of the task name “date stamp”. Further, the “invalid” mark 54a is associated with the task 64 of the task name “invalid annotation”. The task 65 of the task name “transfer” is not associated with any of the frames 51 to 54.

The frames 51 to 54 are arranged in the document template 50, and the tasks 61 to 65 are arranged in the area 60 of the workflow in the order of execution from left to right. As a result, the fixed form 40 is completed (see FIG. 3). The “invalid” mark 54a can be added to any position in the frame 54.

Here, in this exemplary embodiment, the area 60 of the workflow is a task array in a horizontal row, but the present disclosure is not limited to this, and a task array in a vertical row may be employed. Further, the positional relationship between the document template 50 and the area 60 of the workflow is also not limited, and in addition to an example in which the area 60 of the workflow is located below the document template 50 (see FIG. 3), an example in which the area 60 of the workflow is located above the document template 50 and an example in which the area 60 of the workflow is located on the right side or the left side of the document template 50 may be employed.

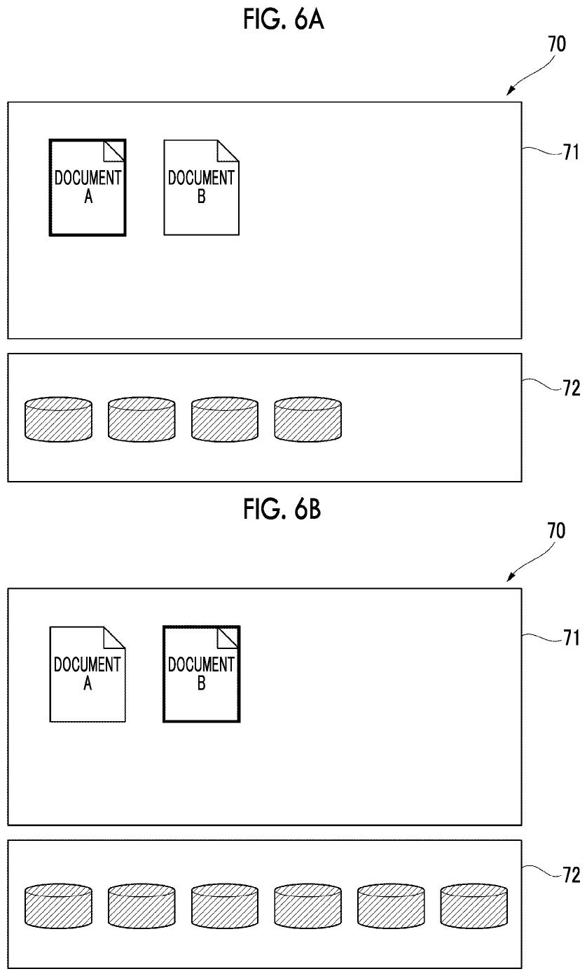

FIGS. 6A and 6B are diagrams showing a state where a plurality of documents are displayed in a workspace 70, FIG. 6A shows a case where a document A is selected from a plurality of documents, and FIG. 6B shows a case where a document B is selected from the plurality of documents.

The workspace 70 makes it possible to display a plurality of fixed forms 40, and in FIGS. 6A and 6B, the document A and the document B are displayed. The workspace 70 is configured to include a document display field 71 in which a plurality of documents are displayed, and a workflow display field 72 in which the workflow corresponding to each document displayed in the document display field 71 is displayed.

In the document display field 71, in FIG. 6A, the document A shown by a thick line is selected, and the document B shown by a thin line is not selected. In FIG. 6B, the document B shown by a thick line is selected, and the document A shown by a thin line is not selected.

In a case where either the document A or the document B displayed in the document display field 71 is selected, the workflow corresponding to the selected document is displayed in the workflow display field 72. That is, in FIG. 6A in which document A is selected, the task of the document A is displayed in the workflow display field 72, and in FIG. 6B in which the document B is selected, the task of the document B is displayed in the workflow display field 72.

For example, in a case where a certain business is composed of a plurality of documents such as a development specification and a business purchase order, each page is sent to different related departments and finally completed as one paper. By using the workspace 70 in creating such a document, it is possible to efficiently proceed with the document creation work. For example, work efficiency can be improved by transferring the document A and the document B to different related departments, stamping a date stamp on the document A and the document B all at once, or bundling the document A and the document B into one.

The user authority may be set so that the tasks that can be executed at the transfer destination change. Further, in addition to the case where the transfer destination is set separately for the document A and the document B, the workspace 70 including a plurality of fixed forms 40 may be created, used, or transferred in a unit of one fixed form.

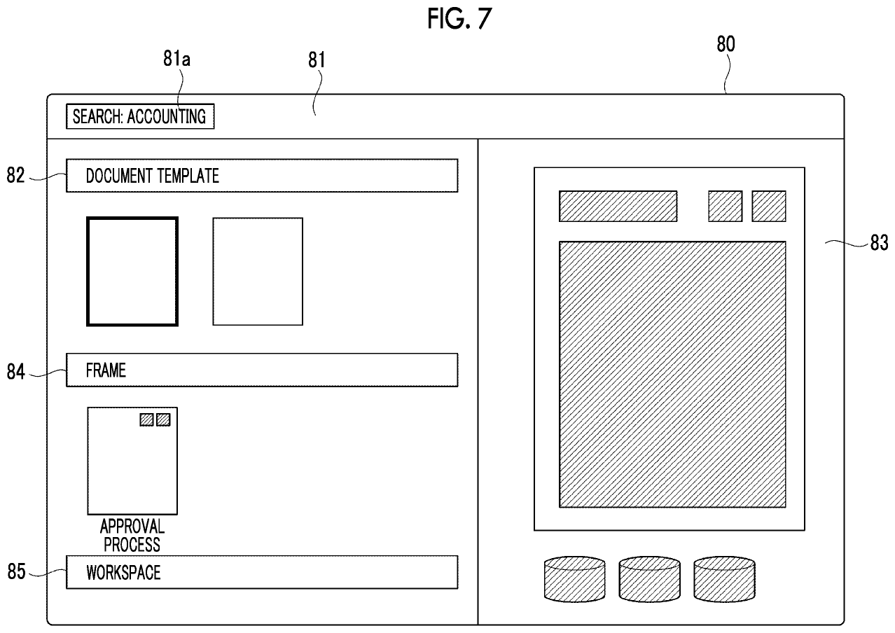

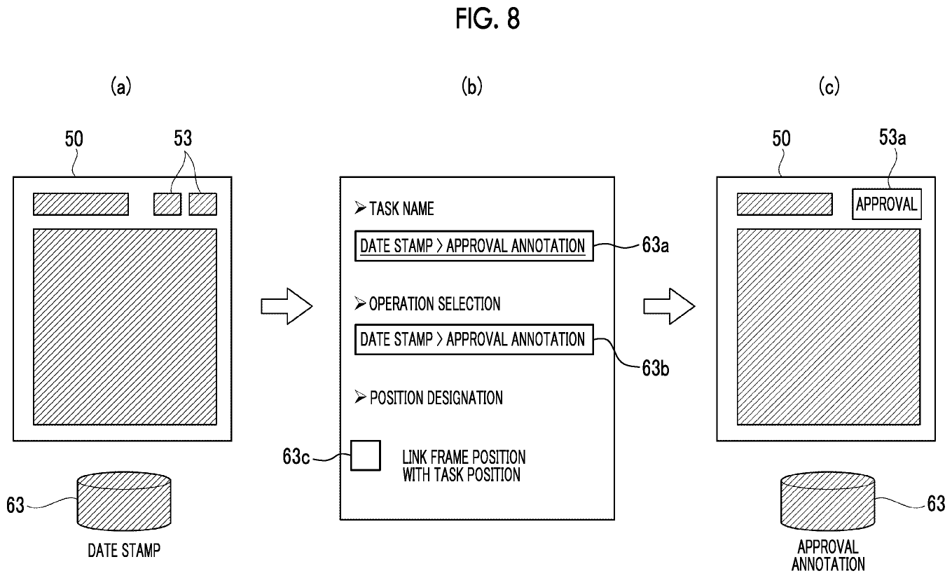

FIGS. 7 and 8 are diagrams illustrating a case where a new fixed form is created using a data resource such as a created fixed form 40. Parts (a) to (c) in FIG. 8 are shown in time series.

In a case of creating a new fixed form, it is possible to create a new fixed form from the beginning or to create a new fixed form by using created data resources. In the case of using the created data resources, as shown in FIG. 7, the display of the user terminal 20 is set to a search screen 80.

The search screen 80 shown in FIG. 7 is configured to include a search area 81, a document template display area 82, a fixed form display area 83, a frame display area 84, and a workspace display area 85.

The search area 81 includes a search word input unit 81a capable of word search for the shared server 30 (see FIG. 1). The document template display area 82 is an area in which the result of the search by the search word input unit 81a of the search area 81 is displayed, and the document template of the fixed form 40 is displayed. In FIG. 7, the document on the left, which is shown by a thick line, is selected.

The fixed form display area 83 is an area in which the fixed form 40 of the document template selected by the user is displayed among the document templates displayed in the document template display area 82. The frame display area 84 is an area in which the associated frame is highlighted in a case where a cursor is positioned on the task displayed in the fixed form display area 83. The workspace display area 85 is an area for displaying the above-mentioned workspace 70 (see FIG. 6).

In a case where the task 63 of the task name “date stamp” shown in a part (a) in FIG. 8 is changed and used for a new fixed form, as shown in a part (b) in FIG. 8, task editing for the task name, operation selection, and position designation is performed. That is, for the task 63, “date stamp>approval annotation” is selected from a task name pull-down menu 63 a, and “date stamp>approval annotation” is selected from an operation selection pull-down menu 63b. Further, in a check box 63c for position designation, in a case where the execution order is not changed according to the position of the frame 53, the check box is not checked.

By such task editing, the frame 53 is changed to an “approval” mark 53 a as the frame, and the task name of the task 63 is changed to “approval annotation”, as shown in parts (c) in FIG. 8. In the case where the setting to change the process is made in this way, the change is reflected in the notation of the frame. In this exemplary embodiment, the position of the frame 53 in a part (a) in FIG. 8 and the position of the “approval” mark 53 a in a part (c) in FIG. 8 are the same.

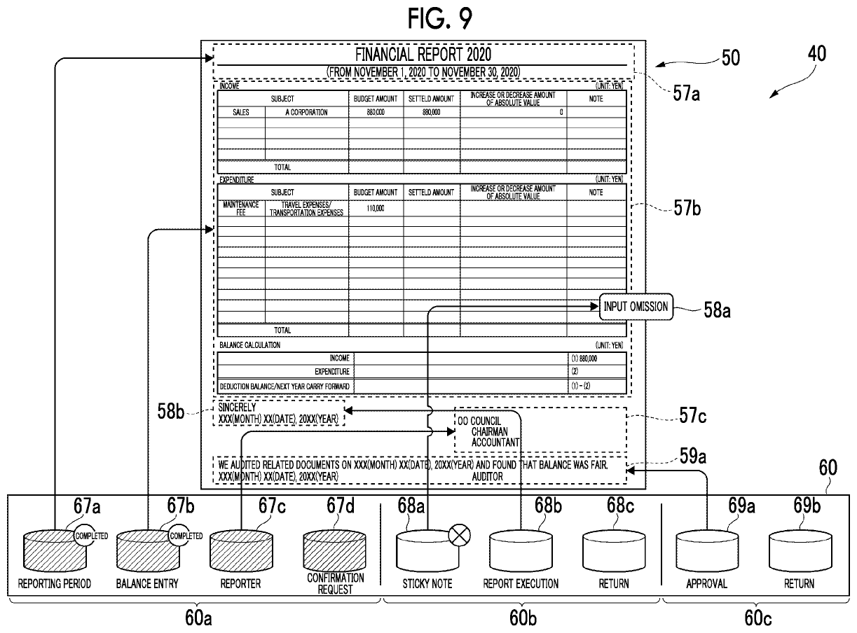

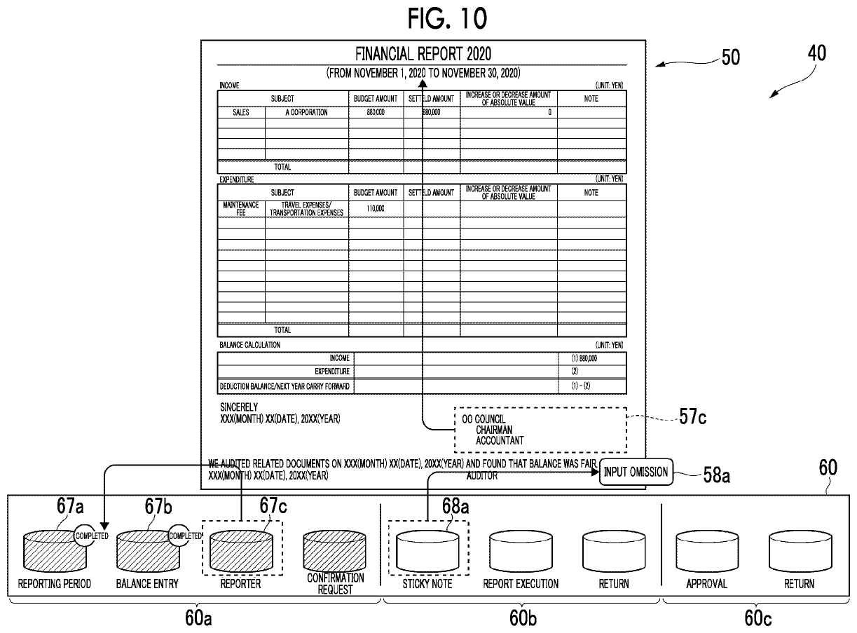

FIGS. 9 and 10 are diagrams illustrating a case where a business document is created using the fixed form 40.

As shown in FIG. 9, the area 60 of the workflow is allocated to each executor, and in this exemplary embodiment, the area 60 of the workflow is divided into an accountant task area 60a, a superior task area 60b, and an audit task area 60c.

In the accountant task area 60a, a task 67a of a task name “reporting period”, a task 67b of a task name “balance entry”, a task 67c of a task name “reporter”, and a task 67d of a task name “confirmation request” are located. All are tasks performed by the accountant or the treasurer.

In the superior task area 60b, a task 68a of a task name “sticky note”, a task 68b of a task name “report execution”, and a task 68c of a task name “return” are located. These are the tasks performed by the superior of the treasurer.

In the audit task area 60c, a task 69a of a task name “approval” and a task 69b of a task name “return” are located.

As described above, in the area 60 of the workflow tasks are executed in the arrangement order from left to right, and similarly, also in the accountant task area 60a, the superior task area 60b, and the audit task area 60c, the tasks are executed in the arrangement order from left to right. Therefore, by looking at the area 60 of the fixed form 40, the task executor can grasp the execution order in the entire flow.

In the fixed form 40 shown in FIG. 9, of the tasks 67a to 67d in the accountant task area 60a, the tasks 67a and 67b are displayed with “completed” added, and it indicates that the tasks 67a and 67b are completed tasks, and the remaining tasks 67c and 67d have not been executed yet. As a result, the treasurer can distinguish between the completed task and the unexecuted task even though the work is interrupted in the middle, and can grasp how far the work has progressed at the time of resumption.

As described above, since each task is associated with the frame of the document template 50, the contents after input are reflected in the frames 57a to 57b associated with the tasks 67a to 67b.

The fixed form 40 shown in FIG. 9 shows a case where the treasurer performs work on the user terminal 20, and the tasks 67a to 67d of the accountant task area 60a are displayed in color. The tasks 68a to 68c and 69a and 69b of the superior task area 60b and the audit task area 60c are displayed in different colors from the tasks 67a to 67d because the tasks are not executed by the treasurer. Therefore, the task executor can easily grasp the task to be performed and can improve the work efficiency.

The progress status in the superior task area 60b and the audit task area 60c can be also checked on the user terminal 20 of the treasurer. In the example shown in FIG. 9, a sticky note 58a of “input omission” is attached at the stage where the task 67d of the accountant task area 60a is designated and the confirmation request is made to the superior. In order to notify the treasurer of the indication from the superior, “x” is added to the task 68a of the superior task area 60b and displayed. The treasurer can easily grasp the progress of the work by first checking the area 60 of the workflow.

In addition to the case where it is allowed to refer to the status of the task for which the execution authority is not granted, it may be possible to select the case where the reference is not allowed.

In addition, the tasks 68a to 68c displayed in the superior task area 60b can be changed by the superior, such as adding another task, as needed. Therefore, it can be made easy to use by customizing according to the situation.

More specifically, as shown in FIG. 10, in a case where the position of the task 67c in the accountant task area 60a is changed between the task 67a and the task 67b, the execution order of the task 67c and the task 67b changes. Then, since the task 67c is a text input type task, the position of the frame 57c associated with the task 67c is changed to the upper position of the document template 50 according to the position change of the task 67c.

Further, in a case where the position of the frame 57c is changed, the position of the task 67c is also changed accordingly.

In this way, the task 67c and the frame 57c have a one-to-one correspondence, and in a case where the position of one of the task 67c and the frame 57c is changed, the position change is reflected in the other one.

It is considered that the arrangement order of the frames and the execution order of the tasks are identical. For example, in the text input type where a natural order is found, automatic sorting is performed. Of course, it may be possible to set so that such automatic sorting is not performed.

On the other hand, it is considered that the position of the task 68a of the task name “sticky note” in the document template 50 is not so high in the need for automatic sorting as compared with the case of the above-mentioned text input type task. Therefore, even though the position of the sticky note 58a in the document template 50 is changed, the arrangement order of the task 68a is not changed, and even though the arrangement order of the task 68a is changed, the position of the sticky note 58a in the document template 50 is not changed.

An anchor is set for the sticky note 58a in order to attach the sticky note 58a to the document template 50. However, the position of such an anchor may be inside the document template 50, and depending on the position setting of the anchor, a part of the sticky note 58a may be outside the document template 50, for example, as shown in FIG. 9.

As described above, the fixed form 40 can edit the execution contents of the task in addition to the change by the position change. For example, in a case where the sticky note task is changed to the date stamp task, a date stamp frame or a date stamp field appears in the document template 50. In the case of a date stamp or the like, since it is considered that the arrangement position and the execution order do not match, a determination that the task position is not changed even though the arrangement position is changed may be made on the user terminal 20.

In FIG. 9, the tasks 67a to 67c are associated with the frames 57a to 57c, respectively. Further, the tasks 68a and 68b are associated with the sticky note 58a and the frame 58b, respectively. Further, the task 69a is associated with the frame 59a.

The tasks 67d, 68c, and 69b are not associated with any of the frames.

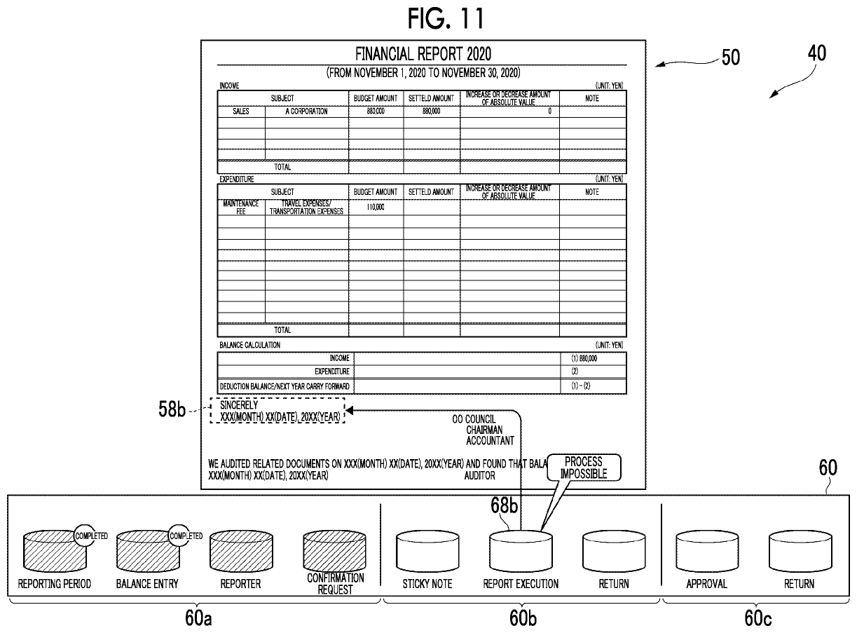

FIG. 11 is a diagram illustrating a case where a business document is created using the fixed form 40, and shows an example in which an error is displayed for the operation of the treasurer.

The example shown in FIG. 11 is for the task name “report execution”. That is, although the task 68b of the task name “report execution” is associated with the frame 58b, since the task is located in the superior task area 60b, it cannot receive the process from the treasurer. In other words, the execution of the process in the frame 58b that is not associated with the process that can be received from the treasurer is prohibited. Therefore, in a case where the treasurer operates the task 68b and the task 68b receives the operation, a display “process impossible” indicating that the process is not possible is performed. Further, the notification by sound output may be performed together with or instead of the display.

In the user terminal 20 of the treasurer referred to here, the frame 58b is an example of a component that is not associated with a process that can be received from the user, and the task 68b is an example of a process whose execution is prohibited in such a component.

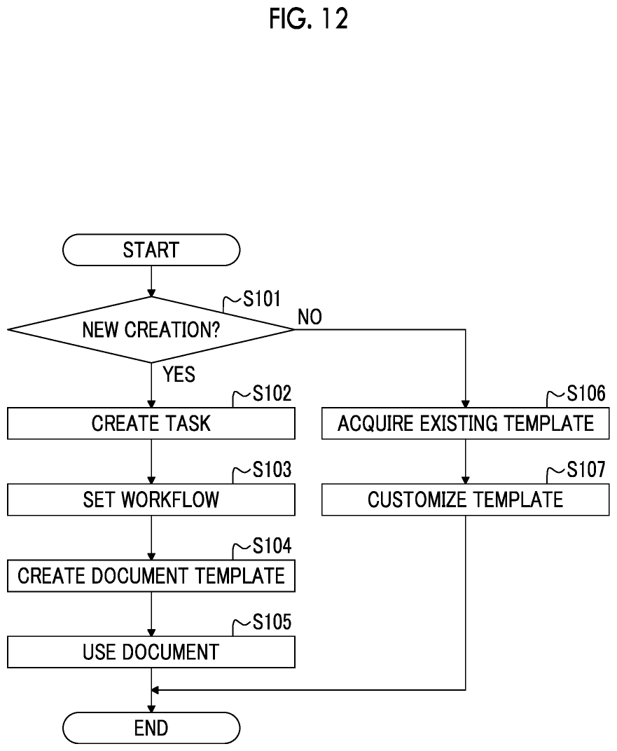

FIG. 12 is a flowchart illustrating a flow of creating and using the fixed form 40. Although the above-mentioned contents are included, it will be described again.

As shown in FIG. 12, the subsequent flow differs depending on whether or not the fixed form 40 is newly created (Step S101). In a case where the fixed form 40 is newly created from the beginning (Yes in Step S101), a task is created for the document on the user terminal 20 (Step S102). The creation of the task is performed by the procedure of determining the task name, determining the operation selection, and determining the designated position (see FIG. 4).

That is, the task name is determined so that the user can identify the task. In addition to the case where the icon to be displayed on the UI is selected or the like, the case where programming or the like is used is also considered.

After that, the type of task to perform on the document is determined. The type of task includes stamping a date stamp, putting a sticky note, and the like. Alternatively, tasks other than document editing, such as sending to other users, are also considered. Options may be designated for the task to increase the degree of freedom.

Then, in a case where the task is document editing, the initial position to perform document editing is determined.

Next, a series of workflows (business flows) are set by combining the tasks created above (Step S103). As a result, the area 60 of the workflow (see, for example, FIG. 3) is created.

After setting the workflow, the document template 50 is created (Step S104). That is, the frame of each task is arranged at any position in the document, and the document template 50 is completed (see, for example, FIG. 3).

By using the fixed form 40 created in this way, a document can be created on the user terminal 20 (S105).

In a case where the fixed form 40 is not newly created from the beginning (No in Step S101), an existing template is first acquired (S106) and customized (S107), and a template that can be used for business is created in order to use the already created data resource.

Here, the input unit 21, the execution unit 22, and the display control unit 24 in the user terminal 20 can be configured by a central processing unit (CPU) or a processor. The CPU reads the program stored in the read only memory (ROM) and executes the program using the random access memory (RAM) as a work area. The program executed by the CPU may be provided to the shared server 30 in a state of being stored in a computer-readable recording medium such as a magnetic recording medium (magnetic tape, magnetic disk, or the like), an optical recording medium (optical disc or the like), an optical magnetic recording medium, or a semiconductor memory. Further, the program executed by the CPU may be downloaded to the shared server 30 by using communication means such as the Internet.

The program executed by the CPU realizes a reception function for receiving a process from the user and an execution function for executing the process on the component associated with the received process.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
receive a process from a user; and
execute the process on a component that is associated with the process and constitutes at least a part of a fixed form.

2. The information processing apparatus according to claim 1, wherein execution of the process is prohibited in a component that is not associated with the process among components constituting at least a part of the fixed form.

3. The information processing apparatus according to claim 2, wherein, in a case where a process is received from a user in the component that is not associated with the process, a display indicating that the process is not possible is performed.

4. The information processing apparatus according to claim 1,
wherein a process execution element that receives the process from the user and the component on which the process execution element executes the process are displayed, and
in the fixed form, in a case where a position of the component is changed, a position of the process execution element associated with the component whose position has been changed is also changed.

5. The information processing apparatus according to claim 4,
wherein the process execution element is executed in an order determined according to an arrangement position, and
in a case where the position of the component is changed, the arrangement position of the process execution element associated with the component whose position has been changed is also changed.

6. The information processing apparatus according to claim 1,
wherein a process execution element that receives the process from the user and the component on which the process execution element executes the process are displayed, and
in a case where a position of the process execution element is changed, a position of the component associated with the process execution element whose position has been changed is also changed.

7. The information processing apparatus according to claim 1,
wherein the component and a process execution element by which the process received from the user is executed in an order determined according to an arrangement position are displayed, and
a case where, with a change in a position or the arrangement position in the fixed form of one of the component and the process execution element, the position or the arrangement position in the fixed form of the other one is changed according to the change, and a case where the position or the arrangement position in the fixed form of one of the component and the process execution element is changed but the position or the arrangement position in the fixed form of the other one is not changed are selectable.

8. The information processing apparatus according to claim 1, wherein, in a case where a setting for changing the process of a process execution element that receives the process from the user is made, the change is reflected in a notation of the component.

9. A non-transitory computer readable medium storing a program causing an information processing apparatus to realize:
a reception function of receiving a process from a user; and
an execution function of executing the process on a component that is associated with the process and constitutes at least a part of a fixed form.

10. An information processing apparatus comprising:
means for receiving a process from a user; and
means for executing the process on a component that is associated with the process and constitutes at least a part of a fixed form.
